(19) United States
(12) Patent Application Publication
(10) Pub. No.: US 2012/0031941 A1
(43) Pub. Date: Feb. 9, 2012

(54) POSITIONING MEMBER FOR BICYCLE RACKS

(76) Inventor: Jack C.T. SHEN, Taichung (TW)

(21) Appl. No.: 13/273,944

(22) Filed: Oct. 14, 2011

Related U.S. Application Data
(63) Continuation-in-part of application No. 12/426,212, filed on Apr. 17, 2009.

(51) Int. Cl. B60R 11/00

(52) U.S. Cl. 224/555

(57) ABSTRACT

A positioning member for bicycle racks includes an integral body made of resilient material and a passage defined through the body so that the bicycle rack extends through the passage. At least two support surfaces are located at outside of the body and have different widths. The at least two support surfaces are perpendicular to an axis of the passage. The support surfaces are chosen to support bicycles of different sizes. Thus, the positioning member of the present invention is provided for kinds of bicycles with simplified structure.

The present invention is a continuation-in-part of application Ser. No. 12/426,212, filed Apr. 17, 2009, the entire contents of which are hereby incorporated by reference.

### BACKGROUND OF THE INVENTION

### Field of the Invention

A conventional bicycle rack is connected to rear end of a vehicle, and multiple positioning members are connected to the bicycle rack so as to support and fasten the bicycles on the bicycle rack.

The conventional positioning members of the bicycle racks have predetermined shape and size so that only some of the bicycle frames can be carried on the bicycle rack. However, there are so many different brands of bicycles available in the market and these bicycles have different shapes and sizes. If the positioning members that equipped with the bicycle rack do not fit the bicycle frame, the bicycle rack would unable to be utilized for carrying the bicycle stably. Besides, the positioning members are fixed to the bicycle rack so that the users have to purchase another bicycle rack with suitable positioning members for the bicycles to be carried.

To fit with the bicycles mentioned before, positioning members are provided in US 2006/0091173 and U.S. Pat. No. 6,286,738. The positioning members are capable of being adjusted so as to fit with bicycles which are provided in several different standards.

However, structures of the positioning members are too complicated to cut the production cost down. To elaborate, each of the positioning members includes two bicycle rack holders. Further, connectors for the holders are also indispensable to the positioning members. Thus, cost of the positioning members would be inevitably raised and product competitiveness would be low.

In addition, excessively detailed adjustment is not necessary for user. Most of bicycler would not pay for more than three bicycles. That is to say, a positioning member who has suitable quantities of using modes for adjustment and fitness for bicycles is just enough. And that would also help in cutting cost down and raising product competitiveness.

The present invention intends to provide a positioning member for bicycle racks, and multiple support surfaces are provided in the positioning member so as to support the bicycles of several sizes.

### SUMMARY OF THE INVENTION

The main object of the present invention is to provide a positioning member for bicycle racks, and the positioning member which includes multiple support surfaces of different widths has simplified structure.

To achieve the above and other objects, a positioning member for bicycle racks of the present invention includes an integral body.

The integral body has a passage defined therethrough and at least two support surfaces located at outside of the body. The at least two support surfaces are perpendicular to an axis of the passage and adapted to support bicycles of different sizes. The body has at least two connection portions corresponding to the support surfaces.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view showing a first embodiment of the present invention;

FIG. 2 is a perspective view showing a first embodiment of the present invention;

FIG. 3 is a top view of a body of a first embodiment of the present invention;

FIG. 4 is a bottom view of a body of a first embodiment of the present invention;

FIG. 5 is a schematic drawing showing a bicycle which is supported on a bicycle rack by a positioning member of a first embodiment of the present invention;

FIG. 6 is a schematic drawing showing a connection condition of the positioning member and a bicycle of a first embodiment of the present invention;

FIG. 7 is a perspective view showing a second embodiment of the present invention;

FIG. 8 is a front view of a body of a second embodiment of the present invention; and

FIG. 9 is a schematic drawing showing a connection condition of the positioning member and a bicycle of a second embodiment of the present invention.

### DETAILED DESCRIPTION OF THE PREFERRED EMBODIMENT

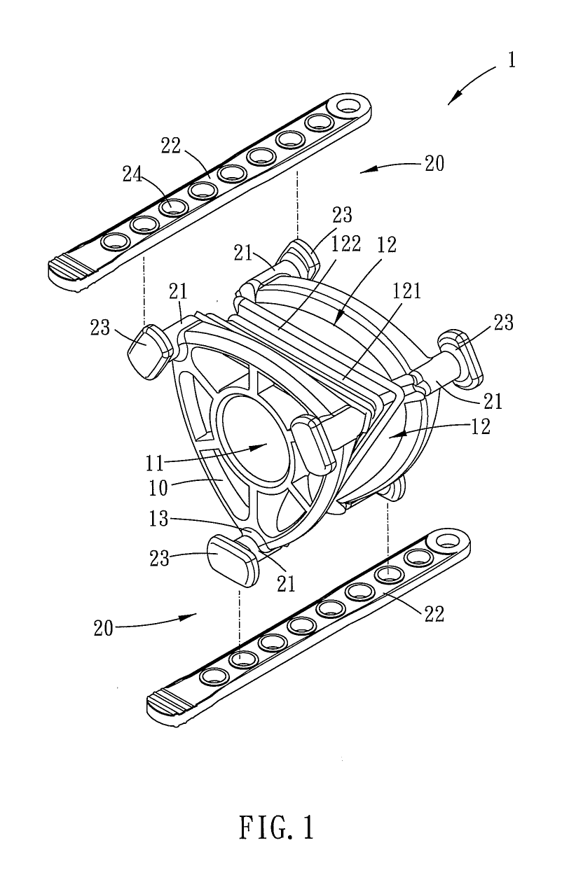

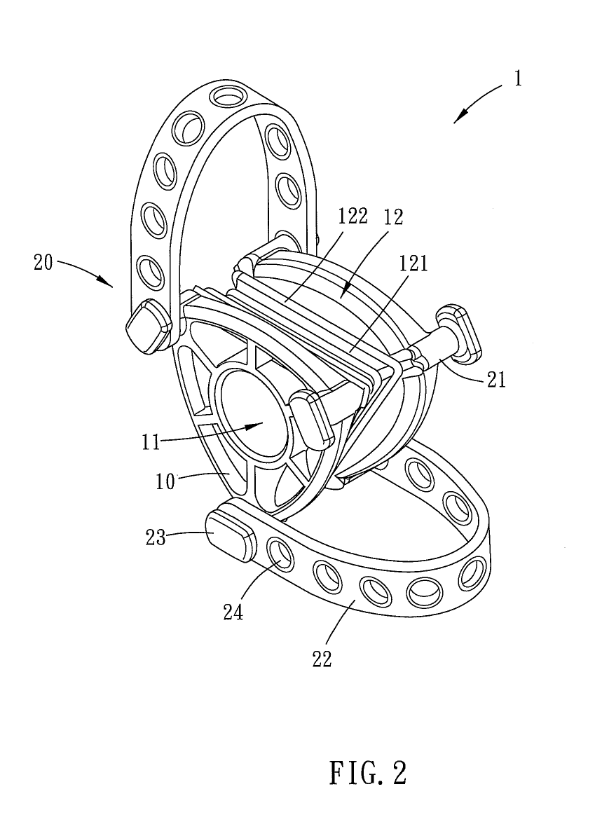

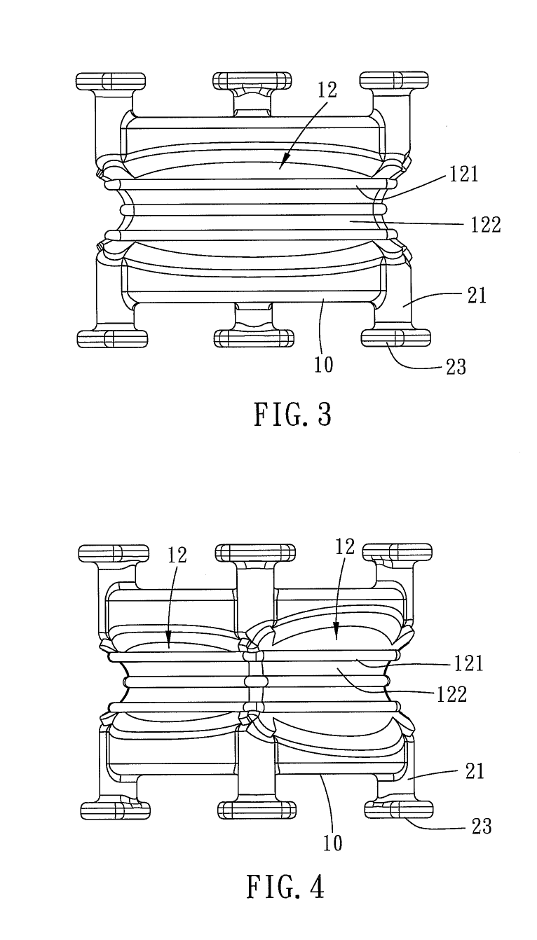

Referring to FIGS. 1 to 4, the positioning member 1 for a bicycle rack of the present invention comprises an integral and polygonal body 10 having a passage 11 defined therethrough and at least two support surfaces 12 are located at outside of the body 10. In the present embodiment, the body 10 is formed as a trihedral prism substantially and includes three support surfaces 12. Note that integral body means that the body is formed in single piece. The support surfaces 12 are perpendicular to an axis of the passage 11. A corner portion 13 is formed between the adjacent support surfaces 12 so that there are three corner portions 13. The support surfaces 12 have different widths so as to support bicycles 4 of different sizes. Each support surface 12 includes multiple lengthwise ribs 121, and grooves 122 are defined between the ribs 121. The ribs 121 are made of resilient material so that they can be deformed when supporting bicycles 4. The body 10 and the ribs 121 can be made by resilient material such as rubber or silicone rubber which prevents from scraping the bicycles 4 and are light in weight.

Furthermore, the body 10 has connection portions corresponding to the support surfaces 12. More particular, the body 10 is formed with connection portions adjacent to every ends of the support surfaces 12 respectively at where the corner portions 13 are formed. In other words, the connection portions are located at the corner portions 13 respectively. Each of the connection portions includes two protrusions 21 extending from two opposite sides of the body 10. The two protrusions 21 extend from the corner portions 13 and each have an enlarged head 23.

The positioning member further includes two or more flexible bands 22. Each of the flexible bands 22 has multiple holes 24 for receiving the protrusions 21 therein, and each hole 24 is smaller than a maximum diameter of the enlarged head 23 such that when the protrusions 21 extend through the holes 24, the enlarged head 23 passes through the one of the holes 24 to ensure that the flexible band 22 does not separated from the protrusion 21.

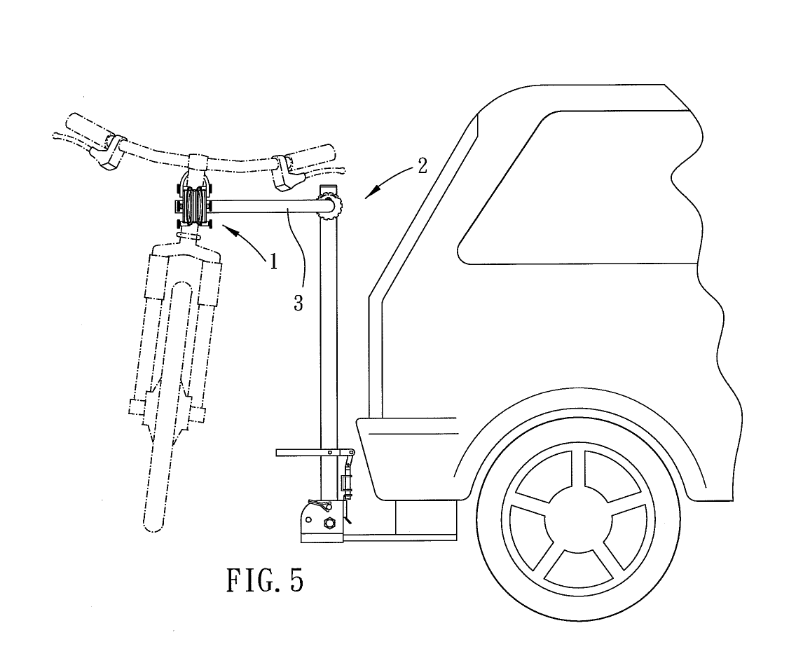

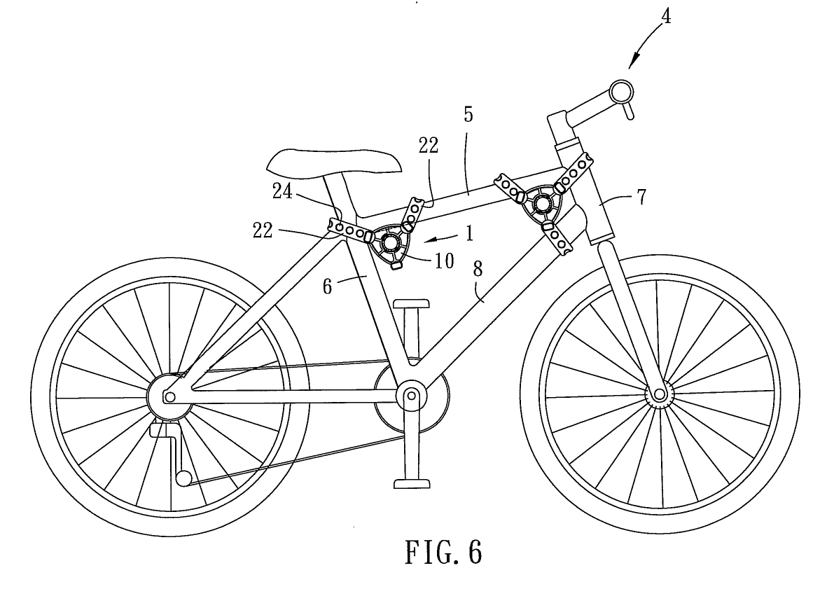

As shown in FIGS. 5 and 6, the bicycle rack 2 is connected to the rear end of a vehicle, and a support rod 3 of the bicycle rack extends through the passage 11 of the body 10. The top tube 5 of the bicycle 4 is supported by one of the support surfaces 12 and the flexible bands 22 have two ends connected to the two protrusions 21 on two opposite sides of the body 10 and secure the top tube 5 to the body 10.

It is noted that the flexible bands 22 can be pivotable relative to the protrusions 21 so that the flexible bands 22 can secure the top tube 5, the seat tube 6, the head tube 7 or the down tube 8 of the bicycle 4 as needed. The flexible bands 22 may have one end fixed to the body 10, and the other end of the flexible bands 22 secure the bicycle 4 and are connected to the protrusions 21.

The body 10 of the positioning member 1 includes multiple support surfaces 12 which have different widths such that the bicycles 4 of different sizes can be secured by the body 10 by choosing suitable support surfaces 12. Further, when the support surface 12 does not fit with the bicycle 4, user may interchange the support surface 12 which abuts the bicycle 4 by rotating the body 10. Thus, using condition can be adjusted easily.

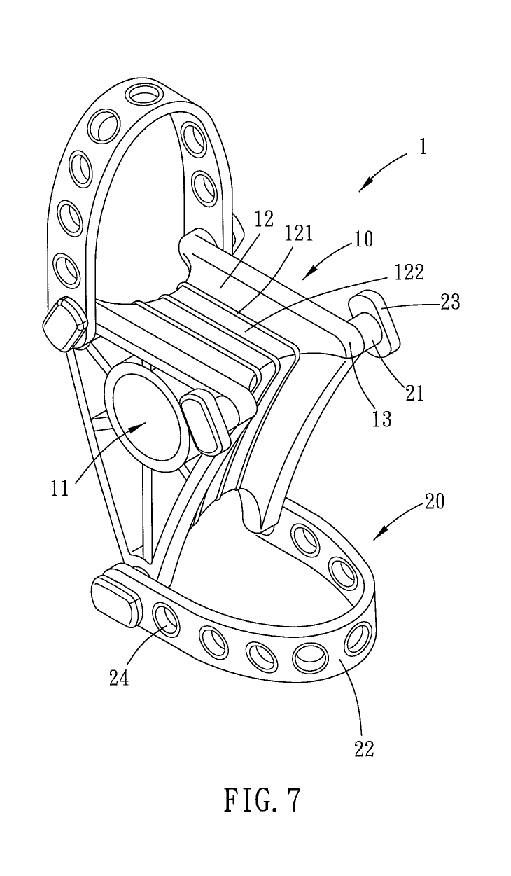

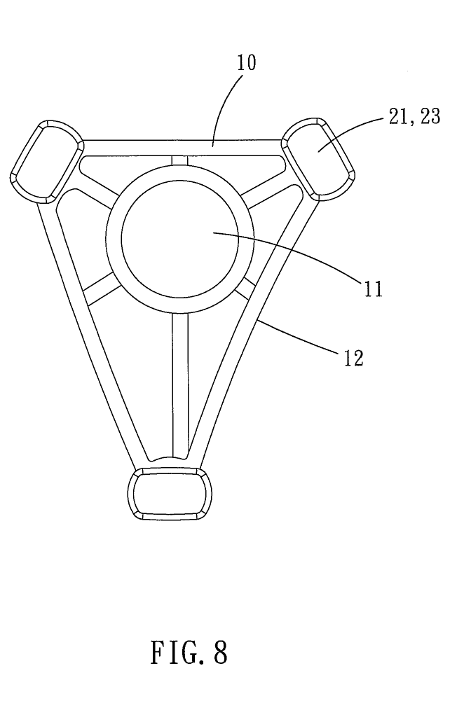

Please refer to FIGS. 7 and 8. In another embodiment of the present invention, the support surfaces 12 of the body may have lengths unique from others. Thus, the body 10 is formed as a non-regular prism.

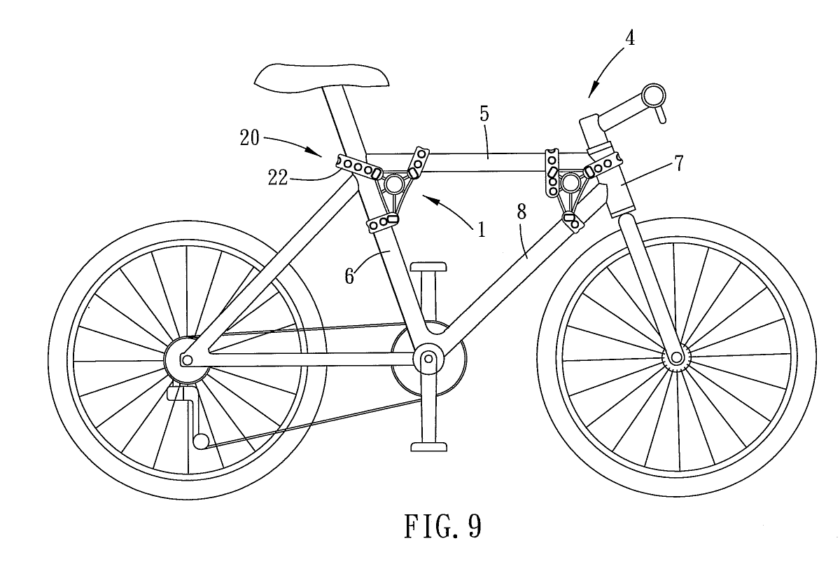

By the appearance, non-regular prism, of the body mentioned before, the body 10 can fit with bicycles 4 which are provided with several standards as needed. Please refer to FIGS. 7 and 9, the support surfaces of the body 10 can fit with both of the top tube 5 and the seat tube 6 simultaneously. Thus, the bicycle 4 can be fixed on the bicycle rack firmly with the body 10. In addition, angles between every two adjacent support surfaces 12 are different from others since each support surface 12 has unique length. Thus, the body 10 can fit with the angle between the top tube 5 and the seat tube 6 by choosing a suitable corner portion from the body 10. That is to say, the support surfaces 12 may still fit with top tube 5 and seat tube 6 even if the angle between the top tube 5 and the seat tube 6 is changed. The body 10 would be suitable for multiple standards of bicycle. As the body 10 is formed as a trihedral prism, the body 10 is capable of fitting with at least three standards of bicycle.

To conclude, the positioning member of the present invention is suitable for bicycles which are provided with several standards, and it is contributed by structure of the body. In addition, structure of the body or the positioning member is simplified. Durability and marketing competitiveness would be benefitted since then.

While we have shown and described the embodiment in accordance with the present invention, it should be clear to those skilled in the art that further embodiments may be made without departing from the scope of the present invention.

What is claimed is:

1. A positioning member for bicycle racks, comprising:
an integral body having a passage defined therethrough and at least two support surfaces located at outside of the body, the at least two support surfaces being perpendicular to an axis of the passage and adapted to support bicycles of different sizes, the body having at least two connection portions corresponding to the support surfaces.

2. The positioning member of claim 1, wherein the body is formed with connection portions adjacent to every ends of the support surfaces respectively.

3. The positioning member of claim 1, wherein each of the connection portions comprises two protrusions extending from two opposite sides of the body, each of the protrusions has an enlarged head.

4. The positioning member of claim 2, wherein each of the connection portions comprises two protrusions extending from two opposite sides of the body, each of the protrusions has an enlarged head.

5. The positioning member of claim 3, wherein the positioning member further comprises at least two flexible band, the flexible band has multiple holes for receiving the protrusions therein, each of the holes is smaller than a maximum diameter of the enlarged head.

6. The positioning member of claim 4, wherein the positioning member further comprises at least two flexible band, the flexible band has multiple holes for receiving the protrusions therein, each of the holes is smaller than a maximum diameter of the enlarged head.

7. The positioning member of claim 1, wherein the body has three support surfaces so as to be formed as a polygonal prism, each of said support surfaces has a length unique from others, so that the body is formed as a non-regular prism, the body is adapted for a top tube and a seat tube of a bicycle to fit simultaneously therewith.

8. The positioning member of claim 7, wherein corner portions are formed between adjacent support surfaces, and each of the connection portions is located at one of the corner portions.

9. The positioning member of claim 1, wherein the at least two support surfaces have different widths.

10. The positioning member of claim 7, wherein each of the support surfaces has a width unique from others.

11. The positioning member of claim 1, wherein the positioning member is made by resilient material.

12. The positioning member of claim 7, wherein the positioning member is made by resilient material.
